(19) United States
(12) Patent Application Publication
(10) Pub. No.: US 2018/0222763 A1
(43) Pub. Date: Aug. 9, 2018

(54) LIQUID-CRYSTAL-DISPLAY PROTECTION PLATE AND METHOD FOR PRODUCING LIQUID-CRYSTAL-DISPLAY PROTECTION PLATE

(71) Applicant: SUMITOMO ELECTRIC INDUSTRIES, LTD., Osaka-shi, Osaka (JP)

(72) Inventors: Keiichiro GESHI, Osaka (JP); Shigeru NAKAYAMA, Osaka (JP); Masashi YOSHIMURA, Osaka (JP)

(73) Assignee: SUMITOMO ELECTRIC INDUSTRIES, LTD., Osaka-shi, Osaka (JP)

(21) Appl. No.: 15/505,938

(22) PCT Filed: Aug. 28, 2015
(86) PCT No.: PCT/JP2015/074323

§ 371 Date: Feb. 23, 2017

(30) Foreign Application Priority Data
Sep. 12, 2014 (JP) 2014-186571

(51) Int. Cl. C01F 7/16; G02B 1/14

(52) U.S. Cl. CPC C01F 7/162; G02F 1/1333; C01P 2002/32; G02B 1/14

(57) ABSTRACT

Provided are a liquid-crystal-display protection plate that has a high strength, is produced at a reduced cost, and has a shape including a curved surface; and a method for producing the liquid-crystal-display protection plate. The liquid-crystal-display protection plate is formed of a spinel sintered body. The spinel sintered body has an average grain size of 10 μm or more and 100 μm or less. The liquid-crystal-display protection plate has a shape including a curved surface.

### TECHNICAL FIELD

The present invention relates to a liquid-crystal-display protection plate and a method for producing the liquid-crystal-display protection plate, in particular, to a liquid-crystal-display protection plate formed of a spinel sintered body and a method for producing the liquid-crystal-display protection plate.

### BACKGROUND ART

Liquid crystal screens are often used with protection plates attached for the purpose of protecting the surfaces of the screens from dirt and the outside air. Techniques currently proposed relate to use of substrates of tempered glass or single-crystalline sapphire as protection plates for liquid crystal screens.

### SUMMARY OF INVENTION

### Technical Problem

Tempered glass, which is produced at a low cost, is in need of further improvements in terms of strength and hardness. Single-crystalline sapphire has higher hardness and strength than tempered glass, hence has high performance as a protection plate. However, single-crystalline sapphire is produced at a very high cost, which is a problem toward practical use.

Thus, a technique is considered that uses a spinel sintered body as a material for a liquid-crystal-display protection plate that has a high strength and is produced at a reduced cost.

In these years, various portable devices are becoming increasingly widespread. Under such circumstances, the proposed shapes of the surfaces of liquid crystal screens include, in addition to flat-surface shapes, non-flat-surface shapes including various curved surfaces. Accordingly, there has also been a demand for, as liquid-crystal-display protection plates, protection plates that include curved surfaces.

Referring to FIG. 8A and FIG. 8B, a protection plate including a curved surface may be obtained from a spinel sintered body by, for example, a method of producing a spinel sintered body 6 having a cubic shape, and subjecting the spinel sintered body 6 to curved-surface cutting to thereby cut out a protection plate 100 having a curved surface.

However, in this method, the portion of the spinel sintered body other than the cut-out part leads to production loss. This causes an increase in the production cost, which is problematic.

Accordingly, an object of the present invention is to provide a liquid-crystal-display protection plate that has a high strength, is produced at a reduced cost, and has a shape including a curved surface, and a method for producing the liquid-crystal-display protection plate.

### Solution to Problem

A liquid-crystal-display protection plate according to an embodiment of the present invention is a liquid-crystal-display protection plate formed of a spinel sintered body, the spinel sintered body having an average grain size of 10 μm or more and 100 μm or less, the liquid-crystal-display protection plate having a shape including a curved surface.

A method for producing a liquid-crystal-display protection plate according to an embodiment of the present invention is a method for producing the liquid-crystal-display protection plate according to the above-described embodiment, the method including a step of preparing an inner mold having an outer peripheral surface including a curved surface, and an outer mold that is elastic and covers the outer peripheral surface of the inner mold with a gap width therebetween; a step of filling a gap formed between the inner mold and the outer mold, with a raw material mixture containing spinel particles; a step of applying pressure to the outer mold to obtain a spinel molded body containing the raw material mixture; and a step of sintering the spinel molded body to obtain a spinel sintered body.

A method for producing a liquid-crystal-display protection plate according to an embodiment of the present invention is a method for producing the liquid-crystal-display protection plate according to the above-described embodiment, the method including: a step of preparing a spinel-sintered-body flat plate having an average grain size of 10 μm or more and 100 μm or less; a step of preparing a lower mold including a curved surface, and an upper mold including a curved surface that fits the lower mold; and a step of transforming the spinel-sintered-body flat plate by placing the spinel-sintered-body flat plate between the lower mold and the upper mold, and applying heat and pressure to the lower mold and the upper mold.

### Advantageous Effects of Invention

The above-described embodiments can provide a liquid-crystal-display protection plate that has a high strength, is produced at a reduced cost, and has a shape including a curved surface; and methods for producing the liquid-crystal-display protection plate.

### BRIEF DESCRIPTION OF DRAWINGS

FIG. 1A is a plan view illustrating an example of a liquid-crystal-display protection plate according to an embodiment of the present invention.

FIG. 1B is a sectional view taken along line X-X in FIG. 1A.

FIG. 2A is a plan view illustrating an example of a liquid-crystal-display protection plate according to an embodiment of the present invention.

FIG. 2B is a sectional view taken along line Y-Y in FIG. 2A.

FIG. 3A is a plan view illustrating an example of a liquid-crystal-display protection plate according to an embodiment of the present invention.

FIG. 3B is a sectional view taken along line Z-Z in FIG. 3A.

FIG. 4 is a flowchart illustrating steps for producing a liquid-crystal-display protection plate according to Embodiment 2.

FIG. 5A is an explanatory view of a method for producing a liquid-crystal-display protection plate according to Embodiment 2.

FIG. 5B is an explanatory view of a method for producing a liquid-crystal-display protection plate according to Embodiment 2.

FIG. 5C is an explanatory view of a method for producing a liquid-crystal-display protection plate according to Embodiment 2.

FIG. 5D is an explanatory view of a method for producing a liquid-crystal-display protection plate according to Embodiment 2.

FIG. 5E is an explanatory view of a method for producing a liquid-crystal-display protection plate according to Embodiment 2.

FIG. 6 is a flowchart illustrating steps for producing a liquid-crystal-display protection plate according to Embodiment 3.

FIG. 7A is an explanatory view of a method for producing a liquid-crystal-display protection plate according to Embodiment 3.

FIG. 7B is an explanatory view of a method for producing a liquid-crystal-display protection plate according to Embodiment 3.

FIG. 7C is an explanatory view of a method for producing a liquid-crystal-display protection plate according to Embodiment 3.

FIG. 7D is an explanatory view of a method for producing a liquid-crystal-display protection plate according to Embodiment 3.

FIG. 8A is an explanatory view of an example of a method for producing a liquid-crystal-display protection plate including a curved surface.

FIG. 8B is an explanatory view of an example of a method for producing a liquid-crystal-display protection plate including a curved surface.

### DESCRIPTION OF EMBODIMENTS

### Description of Embodiments of the Present Invention

Embodiments according to the present invention will be first listed and described.

A liquid-crystal-display protection plate according to an embodiment of the present invention is (1) a liquid-crystal-display protection plate formed of a spinel sintered body, the spinel sintered body having an average grain size of 10 μm or more and 100 μm or less, the liquid-crystal-display protection plate having a shape including a curved surface.

The grain size of a spinel sintered body affects the strength of the spinel sintered body. When a spinel sintered body has an average grain size of 10 μm or more and 100 μm or less, the spinel sintered body has a high strength. Thus, a liquid-crystal-display protection plate formed of this spinel sintered body also has a high strength. Since the liquid-crystal-display protection plate has a shape including a curved surface, it can be used as a protection plate for a liquid crystal screen whose surface includes a curved surface.

(2) The liquid-crystal-display protection plate preferably has a surface roughness Ra of 20 nm or less, more preferably 10 nm or less. In this case, the liquid-crystal-display protection plate has a high optical transmittance, hence can have high image-displaying quality.

(3) The liquid-crystal-display protection plate preferably has a Si element content of 20 ppm or less. In this case, a high optical transmittance can be achieved with stability.

(4) The liquid-crystal-display protection plate preferably has, with a thickness of 1 mm, an average optical transmittance of 85% or more for light of wavelengths of 400 nm to 800 nm. In this case, the liquid-crystal-display protection plate has a high optical transmittance, hence can have high image-displaying quality.

A method for producing a liquid-crystal-display protection plate according to an embodiment of the present invention is (5) a method for producing the liquid-crystal-display protection plate according to any one of (1) to (4) above, the method including: a step of preparing an inner mold having an outer peripheral surface including a curved surface, and an outer mold that is elastic and covers the outer peripheral surface of the inner mold with a gap width therebetween; a step of filling a gap formed between the inner mold and the outer mold, with a raw material mixture containing spinel particles; a step of applying pressure to the outer mold to obtain a spinel molded body containing the raw material mixture; and a step of sintering the spinel molded body to obtain a spinel sintered body.

In this case, occurrence of production loss of a spinel sintered body can be suppressed, to thereby reduce the production cost of a liquid-crystal-display protection plate having a high strength and having a shape including a curved surface.

A method for producing a liquid-crystal-display protection plate according to an embodiment of the present invention is (6) a method for producing the liquid-crystal-display protection plate according to any one of (1) to (4) above, the method including: a step of preparing a spinel-sintered-body flat plate having an average grain size of 10 μm or more and 100 μm or less; a step of preparing a lower mold including a curved surface, and an upper mold including a curved surface that fits the lower mold; and a step of transforming the spinel-sintered-body flat plate by placing the spinel-sintered-body flat plate between the lower mold and the upper mold, and applying heat and pressure to the lower mold and the upper mold.

In this case, occurrence of production loss of a spinel sintered body can be suppressed, to thereby reduce the production cost of a liquid-crystal-display protection plate having a high strength and having a shape including a curved surface.

(7) The method for producing the liquid-crystal-display protection plate according to (5) or (6) above preferably further includes a step of cutting the spinel sintered body. This can provide a liquid-crystal-display protection plate that has a shape suitable for a liquid crystal screen to be protected.

(8) The method for producing the liquid-crystal-display protection plate according to (5) to (7) above preferably further includes a step of polishing a surface of the spinel sintered body. In this case, the optical transmittance of the liquid-crystal-display protection plate is increased, to thereby obtain a liquid-crystal-display protection plate that has high image-displaying quality.

### DETAILS OF EMBODIMENTS OF THE PRESENT INVENTION

Hereinafter, specific examples of liquid-crystal-display protection plates and methods for producing liquid-crystal-display protection plates according to embodiments of the present invention will be described with reference to drawings.

### Embodiment 1

### <Liquid-Crystal-Display Protection Plate>

A liquid-crystal-display protection plate according to an embodiment of the present invention is a liquid-crystal-display protection plate that is formed of a spinel sintered body and has a shape including a curved surface.

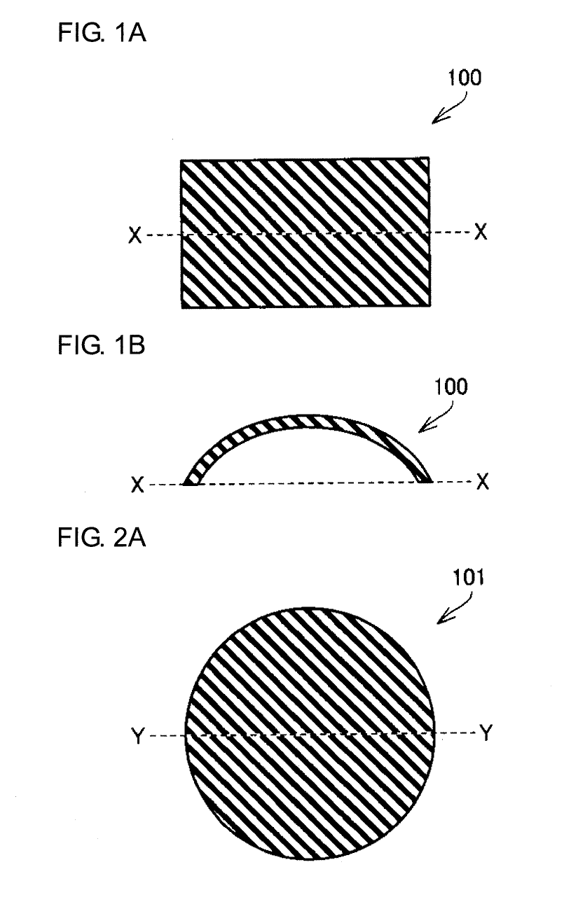

Examples of the shape of the liquid-crystal-display protection plate will be described with reference to FIG. 1A to FIG. 3B.

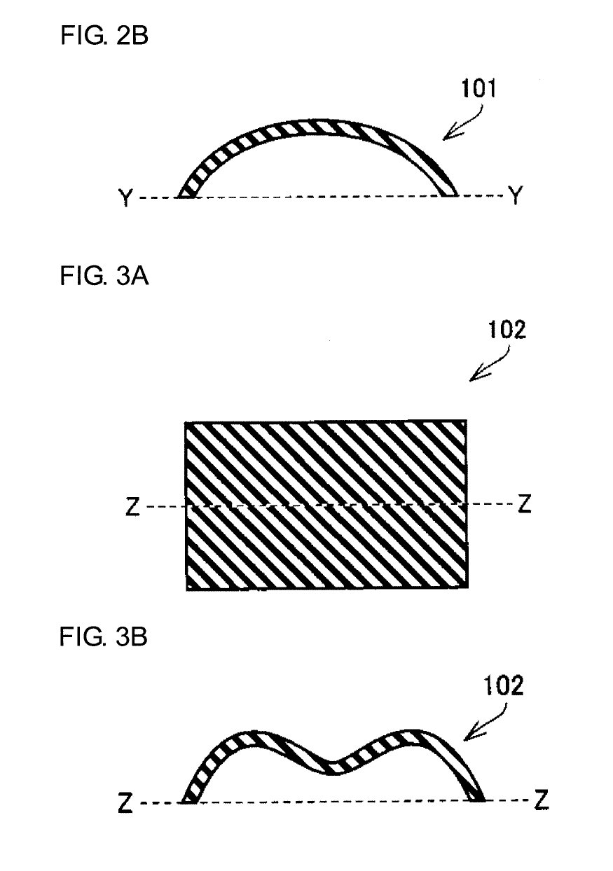

Referring to FIG. 1A and FIG. 1B, a liquid-crystal-display protection plate 100 is rectangular when viewed from above and has a lateral cross section that is arc-shaped. Referring to FIG. 2A and FIG. 2B, a liquid-crystal-display protection plate 101 has the shape of a lens that is circular when viewed from above and has a lateral cross section that is arc-shaped. Referring to FIG. 3A and FIG. 3B, a liquid-crystal-display protection plate 102 is rectangular when viewed from above, and has a lateral cross section including protruding portions and a recessed portion that are constituted by curved lines. The shape of the liquid-crystal-display protection plate is not limited to such shapes, and can be a shape including various curved surfaces suitable for the shape of a liquid crystal screen to be protected. Incidentally, in this Description, the curved surface means a surface that includes a recessed portion and/or a protruding portion; a part of the curved surface may include a flat surface or an angular portion.

The liquid-crystal-display protection plate preferably has a surface roughness Ra of 20 nm or less, more preferably 10 nm or less, still more preferably 5 nm or less. In this case, the liquid-crystal-display protection plate has a high optical transmittance with reduced scattering at the surface, hence can have high image-displaying quality. Incidentally, surface roughness Ra is arithmetic mean roughness defined in JIS standards. Arithmetic mean roughness is one of parameters that express surface roughness and is calculated in the following manner. From the roughness profile of a surface, a portion is sampled, the portion extending, in the direction of the mean line, only for a sampling length from position 0 to position 1. The X-axis is taken to be the direction of the mean line of the sampled portion. The Y-axis is taken to be the direction of vertical magnification. With the roughness profile being represented by y=f(x), arithmetic mean roughness Ra in the region from position 0 to position 1 in the X-axis direction is calculated by the following formula.

$$Ra = \frac{1}{l} {\int }_{0}^{l} \vert f ( x ) \vert dx \qquad [ Math . 1 ]$$

The liquid-crystal-display protection plate preferably has, with a thickness of 1 mm, an average optical transmittance of 85% or more for light of wavelengths of 400 nm to 800 nm. In this case, the liquid-crystal-display protection plate has a high optical transmittance, hence can have high image-displaying quality.

The size of the liquid-crystal-display protection plate is not particularly limited as long as it can cover the surface of the liquid crystal screen.

### <Spinel Sintered Body>

A liquid-crystal-display protection plate according to an embodiment of the present invention is formed of a spinel sintered body.

The spinel sintered body is a sintered body of spinel, which is represented by a compositional formula MgO.nAl₂O₃ (1≤n≤6). The spinel sintered body is polycrystalline, does not have birefringence, and has excellent optical transmission properties. The spinel sintered body also has high mechanical strength and high wear resistance, so that it is less likely to crack and its surface is less likely to become scratched. The spinel sintered body also has high corrosion resistance. Accordingly, a liquid-crystal-display protection plate formed of the spinel sintered body also has excellent optical transmission properties, high mechanical strength, high wear resistance, and high corrosion resistance.

In addition, the spinel sintered body can be produced from an inexpensive raw material by a powder metallurgy technique. This enables production at a low cost. The spinel sintered body is also not limited in terms of shape. Furthermore, the spinel sintered body is more easily worked than sapphire. Accordingly, a liquid-crystal-display protection plate formed of the spinel sintered body can also be produced at a low cost.

The spinel sintered body has an average grain size of 10 μm or more and 100 μm or less. In general, the smaller the size of spinel grains constituting a spinel sintered body, the higher the strength of the spinel sintered body, but the lower the optical transmittance. The inventors of the present invention thoroughly studied the relationships between the size of spinel grains constituting a spinel sintered body and the strength and optical transmission properties of the spinel sintered body. As a result, the inventors have found that, when a spinel sintered body has an average grain size of 10 μm or more and 100 μm or less, the spinel sintered body obtained is highly balanced between strength and optical transmission properties.

The spinel sintered body preferably has an average grain size of 10 μm or more and 100 μm or less, more preferably 20 μm or more and 80 μm or less. With a decrease in the average grain size of a spinel sintered body, for example, to less than 10 μm, the degree of light scattering at grain boundaries increases, which tends to result in degradation of the optical transmission properties of the spinel sintered body. On the other hand, with an increase in the average grain size of a spinel sintered body, for example, to more than 100 μm, the strength of the spinel sintered body tends to decrease in accordance with the Hall-Petch relation.

Incidentally, the average grain size of a spinel sintered body is a value obtained in the following manner: the surface of a liquid-crystal-display protection plate formed of the spinel sintered body is subjected to mirror-polishing with a lapping machine (NF-300 manufactured by Nano Factor Co., LTD.); an area of the surface is then observed with an optical microscope to measure, within the area, the sizes of all the grains of the spinel sintered body; and the grain sizes are averaged.

The spinel sintered body includes pores: the pores preferably have a maximum diameter of 100 μm or less; and the number of pores having a diameter of 10 μm or more per cubic centimeter of the spinel sintered body is preferably 2.0 or less. In this case, scattering of light passing through the spinel sintered body is suppressed, which results in further enhancement of optical transmission properties of the spinel sintered body. In addition, the spinel sintered body also has an increased Weibull coefficient, which is an index of variations in mechanical strength, so that a product with stability can be obtained. This excellent mechanical property is probably provided because the number of pores is small.

The spinel sintered body preferably does not include pores having a maximum diameter of more than 100 μm. The phrase “does not include” means substantially not including; and a trace amount of pores having a maximum diameter of more than 100 μm may be included as long as the light scattering factor is not increased. When the pores have a maximum diameter of 50 μm or less, the light scattering factor further decreases, which is preferable.

The maximum diameters of pores included in the spinel sintered body are measured through observation of an area of the spinel sintered body with a microscope using transmitted light. In general, the maximum diameters of pores can be determined in the following manner: the spinel sintered body is cut so as to have a volume (preferably, a thickness of 10 to 15 mm, a length of 20 mm, and a width of 20 mm); the upper and lower surfaces of the spinel sintered body are polished; the obtained sample is observed in a micrograph, and the diameters of the pores within the micrograph are measured. When such a pore is not spherical, the pore has different diameters depending on directions. Among these diameters, the largest one is defined as the maximum diameter.

Specifically, the spinel sintered body is cut so as to have a thickness of 15 mm, a length of 20 mm, and a width of 20 mm, and the upper and lower surfaces of the spinel sintered body are polished to prepare a sample. Such 10 samples are measured for the diameters of pores. When pores having a maximum diameter of more than 100 μm are not observed in 8 or more samples, pores having a maximum diameter of more than 100 μm are judged as being substantially not included.

The feature that the number of pores having a diameter of 10 μm or more in the spinel sintered body is 2.0 or less per cubic centimeter of the spinel sintered body, is based on a measurement through observation of a volume of the spinel sintered body with a microscope using transmitted light. Specifically, the spinel sintered body is cut so as to have a thickness of 10 to 15 mm, a length of 20 mm, and a width of 20 mm (or plural spinel sintered bodies that have, in total, the same volume as above); the upper and lower surfaces of the spinel sintered body are polished; the obtained sample is observed in a micrograph and the diameters and number of pores are measured. When pores are not spherical, the number of pores having a maximum diameter of 10 μm or more is measured.

A spinel sintered body according to an embodiment of the present invention preferably has a composition MgO.nAl₂O₃ (1.05≤n≤1.30). The value of n is more preferably 1.07≤n≤1.15, still more preferably 1.08≤n≤1.09. In this case, the spinel sintered body is highly balanced between enhancement of strength and enhancement of optical transmission properties. Accordingly, a liquid-crystal-display protection plate formed of this spinel sintered body is also highly balanced between enhancement of strength and enhancement of optical transmission properties.

A spinel sintered body according to an embodiment of the present invention contains impurities: preferably, the impurities have an average grain size of 20 μM or less and the content of the impurities is 10 ppm or less. Impurities contained in the spinel sintered body cause generation of internal defects such as pores to increase the light scattering factor, which results in degradation of optical transmission properties of the spinel sintered body. In addition, impurities affect the refractive index, for example. Accordingly, the smaller the average grain size of impurities, the more preferable it is; the lower the content of impurities, the more preferable it is.

Impurities are contained in the raw material powder or enter the sintered body being produced, so that impurities are contained in the spinel sintered body. Accordingly, the raw material powder is preferably a spinel that has a high purity, preferably a spinel that has a purity of 99.9 mass % or more in terms of the component not removed by sintering. In addition, the sintering step is preferably controlled such that entry of impurities does not occur.

Specific examples of impurities likely to be contained in the raw material powder and impurities likely to enter the sintered body being produced include silicon (Si), tungsten (W), cobalt (Co), iron (Fe), carbon (C), copper (Cu), tin (Sn), zinc (Zn), and nickel (Ni). In the sintering step, such impurities probably coalesce together or deposit to form impurity grains having such sizes that adversely affect optical characteristics, which increase the light scattering factor and affect transmission properties. In particular, the Si element reacts with a spinel powder to form a liquid phase during sintering. The presence of this liquid phase in grain boundaries results in a hetero-phase, which causes a decrease in the optical transmittance. Accordingly, the Si element content is set to 20 ppm or less, so that a high optical transmittance can be achieved with stability. From such a viewpoint, the Si element content is more preferably 10 ppm or less, still more preferably 7 ppm or less. In addition, W, Co, Fe, C, Cu, Sn, Zn, and Ni coalesce together or deposit, which results in a decrease in optical transmittance. Accordingly, the purity of the raw material powder and the sintering step are preferably controlled such that the total content of W, Co, Fe, C, Cu, Sn, Zn, and Ni is 10 ppm or less, more preferably 5 ppm or less.

### Embodiment 2

### <Method for Producing Spinel Sintered Body>

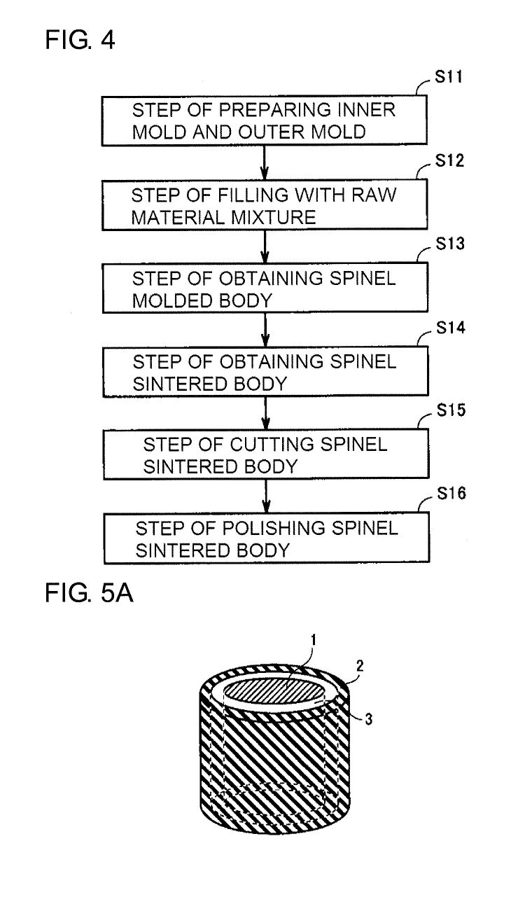

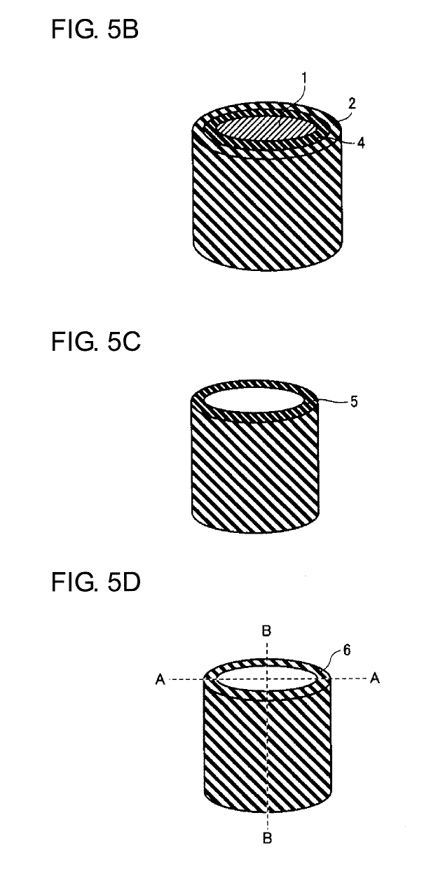

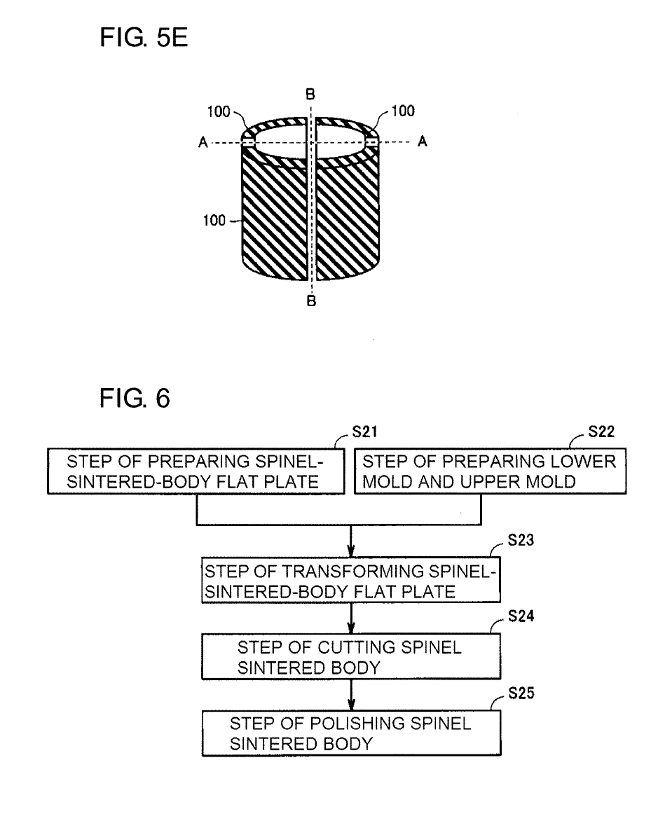

A method for producing a spinel sintered body according to this embodiment will be described with reference to FIG. 4 and FIG. 5A to FIG. 5E. FIG. 4 is a flowchart illustrating steps for producing a liquid-crystal-display protection plate according to Embodiment 2. FIGS. 5A to 5E are explanatory views of a method for producing a liquid-crystal-display protection plate according to Embodiment 2. Incidentally, FIG. 4 and FIG. 5A to FIG. 5E illustrate a method for producing a liquid-crystal-display protection plate that has the shapes illustrated in FIG. 1A and FIG. 1B.

The method for producing a spinel sintered body includes a step (S11) of preparing an inner mold 1 whose outer peripheral surface includes a curved surface, and an outer mold 2, which is elastic and covers the outer peripheral surface of the inner mold 1 with a gap width therebetween; a step (S12) of filling a gap 3 formed between the inner mold 1 and the outer mold 2, with a raw material mixture 4 containing spinel particles; a step (S13) of applying pressure to the outer mold 2 to obtain a spinel molded body 5 containing the raw material mixture 4; and a step (S14) of sintering the spinel molded body 5 to obtain a spinel sintered body 6.

### <Step (S11) of Preparing Inner Mold and Outer Mold>

The inner mold 1 whose outer peripheral surface includes a curved surface is first prepared. The curved surface of the outer peripheral surface of the inner mold 1 corresponds to the shape of the curved surface of a desired liquid-crystal-display protection plate. For example, in order to obtain a liquid-crystal-display protection plate that has the shapes in FIG. 1A and FIG. 1B, an inner mold 1 that is cylindrical may be used. The material for the inner mold 1 is, for example, a metal such as iron.

In addition, the outer mold 2, which is elastic and covers the outer peripheral surface of the inner mold 1 with a gap width therebetween, is prepared. For example, the outer mold 2 may have a cylindrical shape in which the diameter of the inner peripheral surface is, by about 1 mm to about 100 mm, larger than the diameter of the outer peripheral surface of the inner mold 1. The material for the outer mold 2 is, for example, rubber. The outer mold 2 is disposed outside the inner mold 1, to thereby form the gap 3 between the inner mold 1 and the outer mold 2.

<Step (S12) of Filling with Raw Material Mixture>

Subsequently, the gap 3 formed between the inner mold 1 and the outer mold 2 is filled with the raw material mixture 4 containing spinel particles. The raw material mixture 4 can be prepared by the following step.

Spinel particles are first prepared and the spinel particles are dispersed in a dispersant medium to prepare slurry. The slurry can be prepared by adding, and mechanically stirring and mixing appropriate amounts of high-purity spinel particles, a dispersant medium, a dispersant, and the like. Examples of the mechanical stirring and mixing method include a method of mixing with a ball mill, a method of using an ultrasonic tank and applying ultrasonic waves from the outside, and a method of applying ultrasonic waves with an ultrasonic homogenizer. Preferred are the methods using ultrasonic waves because spinel particles are easily dispersed in a dispersant medium and tend to provide homogeneous slurry, and the dispersing methods using ceramic balls and the like tend to cause entry of impurities such as oxides or salts. The time for stirring and mixing should be appropriately adjusted in accordance with the amount of the slurry and the amount of ultrasonic waves applied. For example, when the amount of slurry is 10 liters and an ultrasonic tank with an irradiation capability of about 25 kHz is used, stirring and mixing are desirably performed for 30 minutes or more. Examples of the dispersant medium in which spinel particles are dispersed include water and various organic solvents. After stirring and mixing are performed, the spinel concentration in the slurry may be increased by, for example, static settling, centrifugal separation, or concentration under a reduced pressure with a rotary evaporator or the like.

Subsequently, the slurry is turned into granules by, for example, spray-drying, to thereby obtain the raw material mixture 4.

The slurry may contain a dispersant for achieving homogeneous dispersion, such as an ammonium polyacrylate salt (in a case where the dispersant medium is water) or ethyl oleate, sorbitan monooleate, sorbitan trioleate, or a polycarboxylic acid based dispersant (in cases where the dispersant medium is an organic solvent); or an organic binder for facilitating formation of granules, such as polyvinyl alcohol, polyvinyl acetal, various acrylic polymers, methyl cellulose, polyvinyl acetate, polyvinyl butyral based binders, various waxes, or various polysaccharides.

Spinel particles in the raw material desirably have a high purity. Organic matter, halogens, and water contained in the raw material are removed from the raw material during the primary sintering step and do not cause degradation of characteristics of the spinel sintered body. Accordingly, entry of such impurities is permitted during stages prior to the primary sintering.

### <Step (S13) of Obtaining Spinel Molded Body>

Subsequently, pressure is applied to the outer mold 2 to obtain the spinel molded body 5 containing the raw material mixture 4. Since the outer mold 2 is formed of an elastic material, the application of pressure causes the outer mold 2 to be transformed to contract toward the inner mold 1. On the other hand, since the inner mold 1 is formed of a material that is less likely to be transformed, such as metal, the application of pressure does not cause the inner mold 1 to be transformed. Thus, the raw material mixture 4 filling the gap 3 is pressed due to transformation of the outer mold 2, to turn into the spinel molded body 5. The shape of the spinel molded body 5 can be controlled with the shape of the outer peripheral surface of the inner mold 1 and the shape of the inner peripheral surface of the outer mold 2.

The method of applying pressure is, for example, cold isostatic pressing (CIP). The pressure applied is preferably selected from such a range that the spinel molded body after the primary sintering has a relative density in a range of 95% to 98%, in general, 100 to 300 MPa.

### <Step (S14) of Obtaining Spinel Sintered Body>

Subsequently, the spinel molded body 5 is sintered to obtain the spinel sintered body 6. The sintering step may include a primary sintering step and a secondary sintering step.

In the primary sintering, the spinel molded body 5 is sintered by heating in a predetermined ordinary pressure or reduced pressure (vacuum) atmosphere at 1500° C. to 1900° C. The ordinary pressure or reduced pressure (vacuum) atmosphere is preferably a reducing atmosphere such as hydrogen or an atmosphere of an inert gas such as Ar. The pressure of the atmosphere is preferably a reduced pressure (vacuum), specifically, preferably about 1 to about 200 Pa. The time for the primary sintering is preferably about 1 to about 5 hours.

The spinel primary sintered body after the primary sintering preferably has a relative density in a range of 95% to 98%. The relative density represents a ratio (theoretical density ratio, expressed in %) of the actual density to the theoretical density (3.60 g/cm³ at 25° C.) of a spinel. For example, a spinel having a relative density of 95% has a density (25° C.) of 3.42 g/cm³.

When the spinel primary sintered body has a relative density of less than 95%, sintering in the secondary sintering step is less likely to proceed and a transparent spinel sintered body is less likely to be obtained. On the other hand, when the relative density is more than 98%, coalescence of pores present within the spinel molded body is likely to proceed in the secondary sintering step, which tends to result in generation of pores having a maximum diameter of more than 100 μm. In addition, the number of pores is increased, which results in a decrease in the probability of obtaining a spinel sintered body in which the number of pores having a diameter of 10 μm or more per cubic centimeter of the spinel sintered body is 2.0 or less.

The density of the molded body before the primary sintering varies depending on the pressure applied by the press during molding. The relative density of the spinel molded body after the primary sintering step varies depending on the density of the molded body before the primary sintering or the temperature or time for the primary sintering. Thus, the relative density in the range of 95% to 98% can be achieved by adjusting the pressure applied by the press during molding or the temperature or time for the primary sintering.

The spinel primary sintered body obtained by the primary sintering step is subjected to secondary sintering. In the secondary sintering, the molded body is sintered by heating under an applied pressure at 1500° C. to 2000° C., preferably 1600° C. to 1900° C. The pressure applied is in a range of 5 to 300 MPa, preferably about 50 to about 250 MPa, more preferably about 100 to about 200 MPa. The time for the secondary sintering is preferably about 1 to about 5 hours. The atmosphere for the secondary sintering is preferably an atmosphere of an inert gas such as Ar.

The relative density of the spinel secondary sintered body after the secondary sintering step is preferably 99.6% or more. The relative density of the spinel molded body after the secondary sintering varies depending on the pressure or temperature in the secondary sintering step and the time for the secondary sintering. Thus, the relative density of 99.6% or more can be achieved by adjusting the pressure or temperature in the secondary sintering step and the time for the secondary sintering.

As described above, adjustments are made such that the spinel sintered body after the secondary sintering step has a relative density of 99.6% or more, so that growth of spinel grains during the sintering step is controlled, and coalescence of fine pores due to growth of spinel grains can be suppressed. As a result, generation of pores having a maximum diameter of more than 100 μm can be suppressed, and a spinel sintered body in which the number of pores is suppressed can be obtained.

### <Step (S15) of Cutting Spinel Sintered Body>

The spinel sintered body 6 obtained by the above-described steps is cut so as to have a predetermined shape, so that it is processed into a liquid-crystal-display protection plate. For example, in order to obtain a liquid-crystal-display protection plate having the shapes illustrated in FIG. 1A and FIG. 1B, the spinel sintered body 6 can be cut along line A-A and line B-B in FIG. 5D.

The method of cutting is not particularly limited. For example, cutting may be performed by irradiation with a laser. The size and thickness of the liquid-crystal-display protection plate are not particularly limited and are preferably determined in accordance with, for example, the size and design of a liquid crystal screen to which the liquid-crystal-display protection plate is applied. In the surface of the liquid-crystal-display protection plate, a through-hole portion may be formed, or a lens may be formed for providing enlarged display of a portion of the liquid crystal screen.

### <Step (S16) of Polishing Spinel Sintered Body>

The spinel sintered body 6 obtained by the above-described steps is polished, so that it is processed into a liquid-crystal-display protection plate. Incidentally, the order of the above-described step (S15) of cutting the spinel sintered body and the step (S16) of polishing the spinel sintered body is not particularly limited and any one of these steps may be performed prior to the other.

The spinel sintered body 6 is preferably polished so as to have a surface roughness Ra of 20 nm or less, preferably 10 nm or less. The method of polishing is not particularly limited. For example, cylindrical grinding can be employed.

### <Step of Forming Antireflecting Coating Layer>

Optionally, an antireflecting coating layer or a layer performing an optical action may be formed on a surface of the liquid-crystal-display protection plate. For example, an antireflecting coating layer may be formed on one or both surfaces of the liquid-crystal-display protection plate to thereby further enhance the optical transmission function.

The antireflecting coating layer is, for example, a layer of a metal oxide or a metal fluoride. The method for forming the antireflecting coating layer may be a known PVD method (physical vapor deposition method), specifically, for example, the sputtering method, the ion plating method, or the vacuum vapor deposition method.

### Embodiment 3

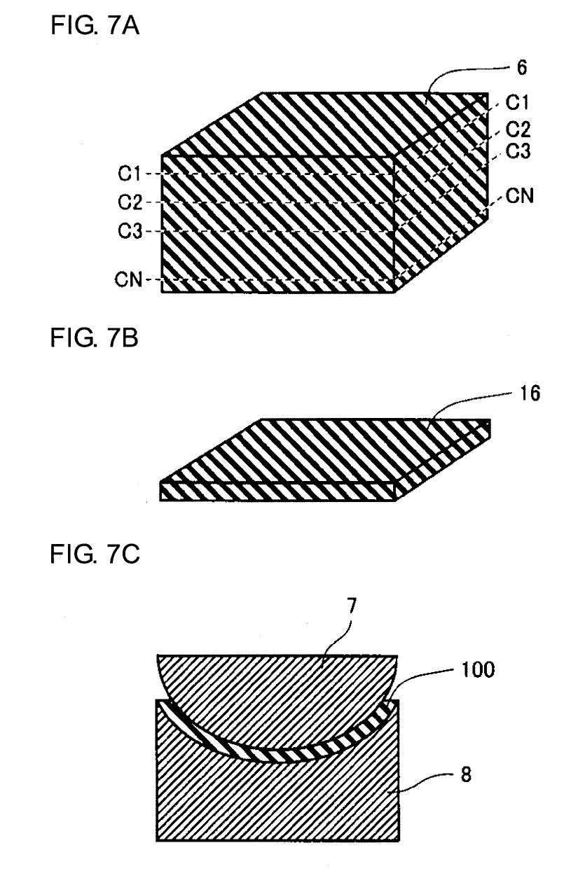

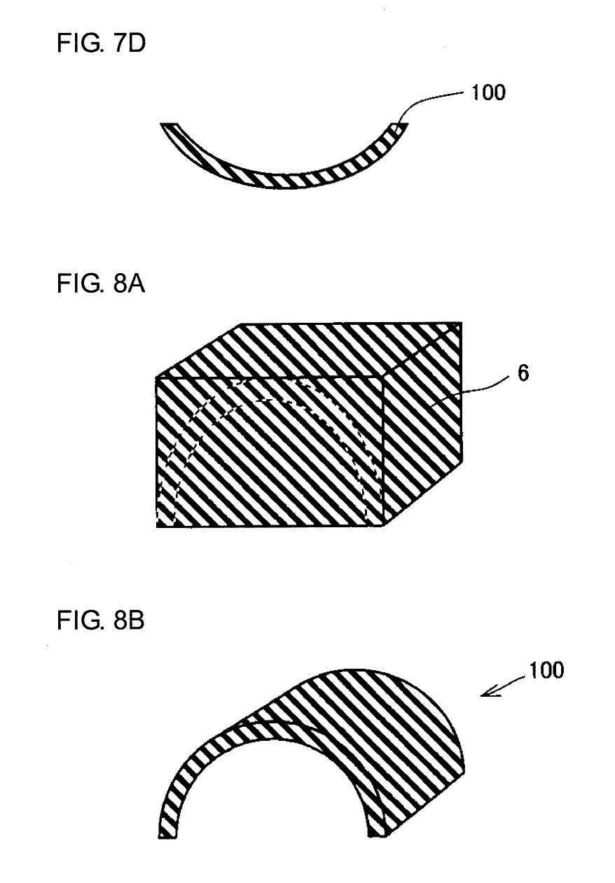

A method for producing a spinel sintered body according to this embodiment will be described with reference to FIG. 6 and FIG. 7A to FIG. 7D. FIG. 6 is a flowchart illustrating steps for producing a liquid-crystal-display protection plate according to Embodiment 3. FIGS. 7A to 7D are explanatory views of a method for producing a liquid-crystal-display protection plate according to Embodiment 3. Incidentally, FIG. 6 and FIG. 7A to FIG. 7D illustrate a method for producing a liquid-crystal-display protection plate that has the shapes illustrated in FIG. 1A and FIG. 1B.

The method for producing a spinel sintered body includes a step (S21) of preparing a spinel-sintered-body flat plate 16 having an average grain size of 10 μm or more and 100 μm or less; a step (S22) of preparing a lower mold 8 including a curved surface, and an upper mold 7 including a curved surface that fits the lower mold 8; and a step (S23) of placing the spinel-sintered-body flat plate 16 between the lower mold 8 and the upper mold 7, and applying heat and pressure to the lower mold 8 and the upper mold 7 to transform the spinel-sintered-body flat plate 16,

### <Step (S21) of Preparing Spinel-Sintered-Body Flat Plate>

The spinel-sintered-body flat plate 16, which has an average grain size of 10 μm or more and 100 μm or less, is first prepared. The spinel-sintered-body flat plate 16 can be produced by, for example, the following method. A raw material mixture that is the same as the raw material mixture used in Embodiment 2 is first prepared. The raw material mixture is filled into a mold used in ordinary production of a spinel sintered body, and then molded and sintered under the same conditions as in Embodiment 2. Thus, for example, a spinel sintered body 6 having a cubic shape is produced. The spinel sintered body 6 can be cut by irradiation of a laser along line C1-C1, line C2-C2, and the like in FIG. 7A so as to have desired thicknesses. Thus, spinel-sintered-body flat plates 16 can be obtained.

### <Step (S22) of Preparing Lower Mold and Upper Mold>

In addition, the lower mold 8 including a curved surface and the upper mold 7 including a curved surface that fits the lower mold 8 are prepared. The shape of the curved surface of the lower mold 8 corresponds to the shape of the liquid crystal screen to be protected. The upper mold 7 includes a curved surface that fits the lower mold 8. The material for the lower mold 8 and the upper mold 7 is not particularly limited and may be a metal such as iron.

### <Step (S23) of Transforming Spinel-Sintered-Body Flat Plate>

Subsequently, the spinel-sintered-body flat plate 16 is placed between the lower mold 8 and the upper mold 7, and heat and pressure are applied to the lower mold 8 and the upper mold 7 to transform the spinel-sintered-body flat plate 16. The heating temperature is preferably 1200° C. or more and 1800° C. or less, more preferably 1200° or more and 1300° C. or less. When the heating temperature is more than 1800° C., the surface of the spinel-sintered-body flat plate 16 may be etched, which may result in degradation of the smoothness of the surface. The pressure applied is preferably 1 MPa or more and 200 MPa or less, more preferably 10 MPa or more and 150 MPa or less.

As a result, the spinel-sintered-body flat plate 16 can be transformed into a shape capable of covering the curved surface of the lower mold 8. Thus, the liquid-crystal-display protection plate obtained by transforming the flat plate 16 can include a shape capable of covering the surface of the liquid crystal screen to be protected.

Subsequently, as in Embodiment 2, a step (S24) of cutting a spinel sintered body 100 and/or a step (S25) of polishing a spinel sintered body 100 can be performed. In addition, a step of forming an antireflecting coating layer may be performed.

### EXAMPLES

The present invention will be described more specifically with reference to examples. However, the present invention is not limited to these examples.

### Example 1

### <Production of Liquid-Crystal-Display Protection Plate>

### Production Example 1

An inner mold that was cylindrical and formed of metal (diameter: 100 mm, length: 50 mm) and an outer mold that was cylindrical and formed of rubber (inner diameter: 120 mm, outer diameter: 140 mm, length: 50 mm) were prepared. The gap thickness between the inner mold and the outer mold was 10 mm.

An ultrasonic tank having a volume of 40 liters was charged with 4750 g of spinel particles (purity: 99.9% or more) having a composition of MgO.nAl₂O₃ (n=1.09), 3100 g of water (dispersant medium), and 125 g of a 40 mass % aqueous solution of ammonium polycarboxylate (dispersant, produced by SAN NOPCO Ltd.: trade name SN-D5468). While ultrasonic waves were applied, the content was stirred and mixed for 30 minutes. After that, 1000 g of a 10 mass % solution of polyvinyl alcohol (produced by KURARAY Co., Ltd.: trade name PVA-205C) as an organic binder, and 10 g of polyethylene glycol #400 (analytical grade reagent) as a plasticizer were added. The content was stirred and mixed for 60 minutes to prepare slurry.

Subsequently, the slurry was turned into granules by spray-drying. The water content of the granules was adjusted to be 0.5 mass %. The granules were then charged into the gap between the inner mold and the outer mold. Primary molding was performed by applying a pressure of 196 MPa to the outer mold. In addition, secondary molding was performed at a pressure of 196 MPa by cold isostatic pressing (CIP) to obtain a spinel molded body. The spinel molded body was cylindrical (inner diameter: 100 mm, outer diameter: 110 mm).

The obtained molded body was placed into a graphite vessel and subjected to primary sintering in a vacuum (5 Pa or less) at 1700° C. for 2 hours. The obtained primary sintered body was measured in terms of relative density by the Archimedes method, and it was found to be 98%.

The primary sintered body was heated and pressed by hot isostatic pressing (HIP) in an Ar atmosphere at an atmosphere pressure of 196 MPa at a temperature of 1700° C. for 2 hours to obtain a secondary sintered body. The obtained secondary sintered body was measured in terms of relative density by the Archimedes method, and it was found to be 99.8%.

The spinel secondary sintered body obtained by the above-described method was cut in the height direction into six equal parts. Both of the main surfaces of such a part were polished with a lapping machine (NF-300 manufactured by Nano Factor Co., LTD.) to obtain a liquid-crystal-display protection plate (volume: 1.0 cm³) having a surface roughness Ra of 8 nm and a thickness of 1 mm. The liquid-crystal-display protection plate has a shape including a curved surface.

### Production Examples 2 to 16

In Production Examples 2 to 16, liquid-crystal-display protection plates having a shape including a curved surface were produced by the same method as in Production Example 1 except that the composition of the raw material spinel particles, conditions of the primary sintering, conditions of the secondary sintering, and the surface roughness Ra of liquid-crystal-display protection plates in Table 1 were employed.

### <Measurements>

### (Mohs Hardness)

Mohs hardness was measured by a method defined in JIS. The results are described in Table 1.

### (Optical Transmission Properties)

The average optical transmittance (%) of such a liquid-crystal-display protection plate for wavelengths of 400 nm to 800 nm was measured. The results are described in Table 1.

### (Bending Strength)

A three-point bending strength was measured by a method defined in JIS. The results are described in Table 1.

### (Observation of Pores)

A surface of the liquid-crystal-display protection plate was observed with an optical microscope (T-300 manufactured by NIKON CORPORATION) at a magnification of 50 times to measure the maximum diameter of pores and the number of pores having a diameter of 10 μm or more per cubic centimeter of the sintered body. The results are described in Table 1.

### (Si Element Content)

The Si element content of the liquid-crystal-display protection plate was measured by ICP emission spectroscopy. The results are described in Table 1.

### (Density)

The relative density of the liquid-crystal-display protection plate was measured by the Archimedes method. The results are described in Table 1.

TABLE 1

| | | | | | | Liquid-crystal-display protection plate | | | | | | | |
|---|---|---|---|---|---|---|---|---|---|---|---|---|---|
| | Composition | | | | | | | | | | Observation of | | |
| | of | Conditions | | Conditions | | Average | | | | | pores (upper | | |
| | MgO•nAl₂ O₃ | of | | of | | grain | | | | | value: maximum | | |
| | of raw | primary | | secondary | | size of | | | Average | | diameter; lower | | |
| Produc- | material | sintering | | sintering | | spinel | Surface | | optical | | value: number of | Si | |
| tion | spinel | Temper- | | Temper- | | sintered | rough- | Mohs | transmit- | Bending | pores having | element | Relative |
| Exam- | particles | ature | Time | ature | Time | body | ness | hard- | tance | strength | diameter of 10 | content | density |
| ple | n | (° C.) | (h) | (° C.) | (h) | (μm) | (nm) | ness | (%) | (MPa) | μm or more) | (ppm) | (%) |
| 1 | 1.09 | 1700 | 2 | 1700 | 2 | 5 | 8 | 8 | 82 | 600 | 20 μm/0 | 5 | 99.8 |
| 2 | 1.09 | 1700 | 2 | 1720 | 2 | 10 | 8 | 8 | 85 | 450 | 10 μm/0 | 7 | 99.6 |
| 3 | 1.09 | 1700 | 2 | 1750 | 2 | 20 | 8 | 8 | 86 | 400 | 22 μm/1.0 | 7 | 99.7 |
| 4 | 1.09 | 1700 | 2 | 1780 | 2 | 50 | 8 | 8 | 86 | 400 | 18 μm/1.0 | 7 | 99.7 |
| 5 | 1.09 | 1700 | 2 | 1800 | 2 | 80 | 8 | 8 | 86 | 380 | 15 μm/0 | 8 | 99.8 |
| 6 | 1.09 | 1700 | 2 | 1850 | 2 | 100 | 8 | 8 | 86 | 350 | 25 μm/1.0 | 7 | 99.7 |
| 7 | 1.09 | 1700 | 2 | 1900 | 2 | 150 | 8 | 8 | 86 | 280 | 24 μm/1.0 | 7 | 99.8 |
| 8 | 1.09 | 1700 | 2 | 1750 | 2 | 20 | 5 | 8 | 86 | 400 | 21 μm/1.0 | 6 | 99.8 |
| 9 | 1.09 | 1700 | 2 | 1750 | 2 | 20 | 10 | 8 | 86 | 400 | 11 μm/0 | 8 | 99.8 |
| 10 | 1.00 | 1700 | 2 | 1750 | 2 | 20 | 10 | 8 | 86 | 400 | 16 μm/0 | 8 | 99.8 |
| 11 | 1.07 | 1700 | 2 | 1750 | 2 | 20 | 10 | 8 | 86 | 400 | 15 μm/0 | 7 | 99.6 |
| 12 | 1.15 | 1700 | 2 | 1750 | 2 | 20 | 10 | 8 | 86 | 400 | 13 μm/1.0 | 8 | 99.8 |
| 13 | 1.20 | 1700 | 2 | 1750 | 2 | 20 | 10 | 8 | 86 | 400 | 20 μm/0 | 8 | 99.7 |
| 14 | 1.30 | 1700 | 2 | 1750 | 2 | 20 | 10 | 8 | 86 | 400 | 18 μm/1.0 | 7 | 99.8 |
| 15 | 1.09 | 1750 | 2 | 1800 | 2 | 80 | 8 | 8 | 86 | 380 | 15 μm/0 | 8 | 99.6 |
| 16 | 1.09 | 1750 | 3 | 1800 | 2 | 80 | 8 | 8 | 86 | 380 | 20 μm/1.0 | 8 | 99.9 |

### <Evaluation Results>

Comparison among Production Examples 1 to 16 indicates that, when a liquid-crystal-display protection plate contains a spinel sintered body having an average grain size of 10 μm or more and 100 μm or less (Production Examples 2 to 6 and 8 to 16), the liquid-crystal-display protection plate has a high average optical transmittance of 85% or more and a high bending strength of 350 MPa or more. In each of Production Examples 2 to 6 and 8 to 16, the surface roughness Ra was 20 nm or less and the Si element content was 20 ppm or less.

### Example 2

### <Production of Liquid-Crystal-Display Protection Plate>

### Production Example 17

A mold was prepared in which a lower mold and an upper mold provided a rectangular parallelepiped space therebetween. The space of the mold was filled with the same raw material mixture as in Production Example 2. Primary molding and secondary molding were performed under the same conditions as in Production Example 2 to obtain a spinel molded body. The spinel molded body had the shape of a rectangular parallelepiped. The obtained spinel molded body was cut by irradiation with a laser to obtain a spinel-sintered-body flat plate having main surfaces that were squares having 100 mm sides, and having a thickness of 3 mm.

Subsequently, a lower mold and an upper mold having the shapes in FIG. 7C were prepared. The spinel-sintered-body flat plate was placed between the lower mold and the upper mold, and heated and pressed at a temperature of 1250° C. and a pressure of 100 MPa to transform the flat plate. After that, both of the main surfaces were polished with a lapping machine (NF-300 manufactured by Nano Factor Co., LTD.) to obtain a liquid-crystal-display protection plate (volume: 1.0 cm³) having a surface roughness Ra of 8 nm and a thickness of 1 mm. The liquid-crystal-display protection plate has a shape including a curved surface.

### <Measurements>

The obtained liquid-crystal-display protection plate was measured in terms of Mohs hardness, average optical transmittance, and bending strength by the same methods as in Example 1. The same results as in Production Example 2 were obtained. This indicates that the liquid-crystal-display protection plate having a shape including a curved surface and obtained by the production method of Production Example 17 has a high optical transmittance and a high strength.

The embodiments disclosed herein should be understood as examples in all respects and not being restrictive. The scope of the present invention is not indicated by the above-described embodiments, but by Claims. The scope of the present invention is intended to embrace all the modifications within the meaning and range of equivalency of the Claims.

### INDUSTRIAL APPLICABILITY

A liquid-crystal-display protection plate according to the present invention has a high optical transmittance and a high strength, and has a shape including a curved surface, hence are suitably applicable to portable devices, for example.

### REFERENCE SIGNS LIST

1 inner mold
2 outer mold
3 gap portion
4 raw material mixture
5 spinel molded body
6 spinel sintered body
7 upper mold
8 lower mold
16 spinel-sintered-body flat plate
100, 101, and 102 liquid-crystal-display protection plates

1: A liquid-crystal-display protection plate formed of a spinel sintered body,
the spinel sintered body having an average grain size of 10 μm or more and 100 μm or less,
the liquid-crystal-display protection plate having a shape including a curved surface.

2: The liquid-crystal-display protection plate according to claim 1, wherein the liquid-crystal-display protection plate has a surface roughness Ra of 20 nm or less.

3: The liquid-crystal-display protection plate according to claim 1, wherein the liquid-crystal-display protection plate has a Si element content of 20 ppm or less.

4: The liquid-crystal-display protection plate according to claim 1, wherein the liquid-crystal-display protection plate has, with a thickness of 1 mm, an average optical transmittance of 85% or more for light of wavelengths of 400 nm to 800 nm.

5: A method for producing the liquid-crystal-display protection plate according to claim 1, the method comprising:
a step of preparing an inner mold having an outer peripheral surface including a curved surface, and an outer mold that is elastic and covers the outer peripheral surface of the inner mold with a gap width therebetween;
a step of filling a gap formed between the inner mold and the outer mold, with a raw material mixture containing spinel particles;
a step of applying pressure to the outer mold to obtain a spinel molded body containing the raw material mixture; and
a step of sintering the spinel molded body to obtain a spinel sintered body.

6: A method for producing the liquid-crystal-display protection plate according to claim 1, the method comprising:
a step of preparing a spinel-sintered-body flat plate having an average grain size of 10 μm or more and 100 μm or less;
a step of preparing a lower mold including a curved surface, and an upper mold including a curved surface that fits the lower mold; and
a step of transforming the spinel-sintered-body flat plate by placing the spinel-sintered-body flat plate between the lower mold and the upper mold, and applying heat and pressure to the lower mold and the upper mold.

7: The method for producing the liquid-crystal-display protection plate according to claim 5, further comprising a step of cutting the spinel sintered body.

8: The method for producing the liquid-crystal-display protection plate according to claim 5, further comprising a step of polishing a surface of the spinel sintered body.
